(19) United States
(12) Patent Application Publication
(10) Pub. No.: US 2005/0261880 A1
(43) Pub. Date: Nov. 24, 2005

(54) Noise compensation for spectrum analyzer

(76) Inventor: Joseph M. Gorin, Santa Rosa, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/852,320

(22) Filed: May 24, 2004

(51) Int. Cl. G06F 15/00

(52) U.S. Cl. 702/191

(57) ABSTRACT

A noise compensation method enables measurements acquired by a spectrum analyzer to be corrected for noise contributed to the measurements by the spectrum analyzer. The correction is based on an established mapping between characterized noise of the spectrum analyzer and operating conditions of the spectrum analyzer, such as gain correction, that is applied to the spectrum analyzer.

### BACKGROUND OF THE INVENTION

The performance of a spectrum analyzer can be degraded by noise that is inherent to the spectrum analyzer. For example, the noise floor of a spectrum analyzer can reduce measurement accuracy if this noise is not isolated from signal measurements that are acquired by the spectrum analyzer. A spectrum analyzer's noise can also limit measurement sensitivity when the noise is sufficiently high relative to the signals being measured to cause the signals to be masked by the noise and go undetected by the spectrum analyzer. Unfortunately, decreasing the noise of the spectrum analyzer to improve measurement accuracy and measurement sensitivity can be costly or difficult to achieve, due to inherent noise within the components of the spectrum analyzer that contribute to the spectrum analyzer's noise. Accordingly, there is motivation to compensate measurements made by a spectrum analyzer for the noise of the spectrum analyzer.

One compensation technique characterizes the noise of the spectrum analyzer and then subtracts the noise from subsequent signal measurements that are performed by the spectrum analyzer. However, this noise characterization accommodates only the particular operating state of the spectrum analyzer at which the signal measurements are acquired. Therefore, in order to compensate for noise in various operating states of a spectrum analyzer using this technique, the noise characterization must be performed at those various operating states, which can increase measurement time for the spectrum analyzer.

### SUMMARY OF THE INVENTION

A noise compensation method according to embodiments of the present invention enables measurements acquired by a spectrum analyzer to be corrected for noise contributed to the measurements by the spectrum analyzer. The correction is based on an established mapping between characterized noise of the spectrum analyzer and operating conditions of the spectrum analyzer, such as gain correction, that is applied to the spectrum analyzer.

### BRIEF DESCRIPTION OF THE DRAWINGS

FIG. 1 shows a simplified block diagram of a spectrum analyzer.

FIG. 2 shows a flow diagram of a noise compensation method for the spectrum analyzer according to embodiments of the present invention.

FIG. 3A shows an exemplary amplitude response of the spectrum analyzer versus frequency.

FIG. 3B shows exemplary gain correction for the spectrum analyzer having the exemplary amplitude response of FIG. 3A.

FIG. 3C shows a corrected amplitude response for the spectrum analyzer with the exemplary gain correction of FIG. 3B applied to the spectrum analyzer.

FIG. 3D shows an exemplary noise profile of the spectrum analyzer versus frequency with the exemplary gain correction of FIG. 3B applied to the spectrum analyzer.

FIG. 4 shows an established mapping between gain and noise for the spectrum analyzer.

### DETAILED DESCRIPTION OF THE EMBODIMENTS

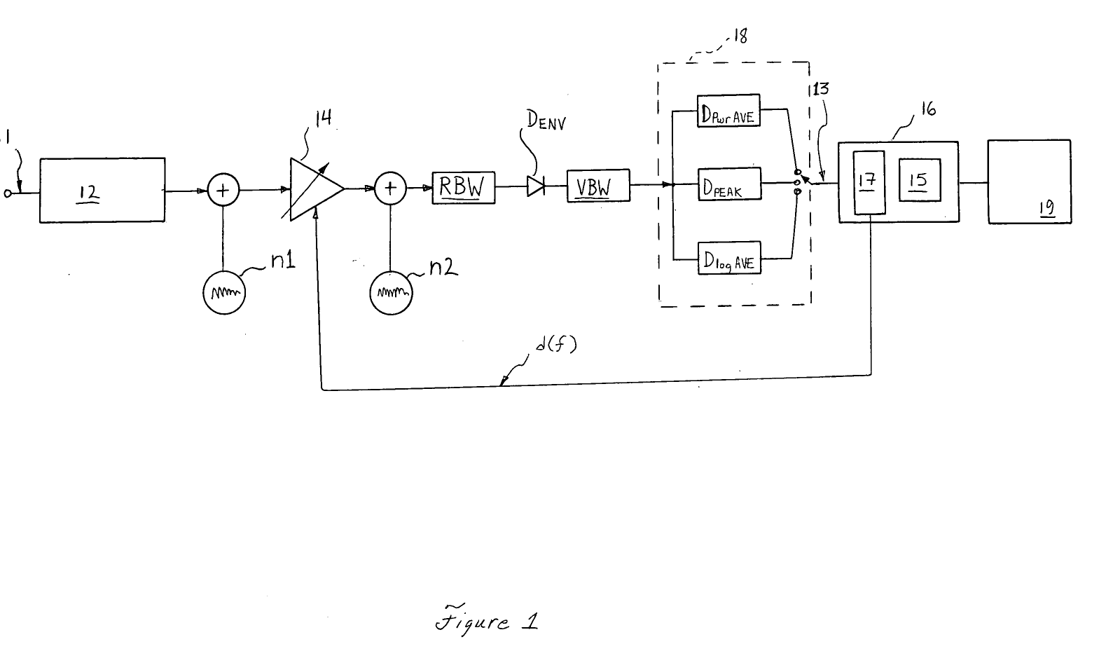

FIG. 1 shows a simplified block diagram of a spectrum analyzer 10. An input signal 11 is applied to a signal path 12 of the spectrum analyzer 10. An exemplary signal path 12 includes one or more attenuators, filters, mixers, couplers, transmission lines and other devices or systems (not shown) used for processing the applied input signal 11 so that the spectrum of the input signal 11 can be characterized.

A gain element 14 having adjustable gain is coupled to the output of the signal path 12. The gain element 14 is typically implemented using one or more amplifiers with adjustable gain, one or more attenuators with adjustable attenuation, or one or more amplifiers cascaded with one or more attenuators with adjustable attenuation. However, any suitable device, element or system having sufficient adjustment range to accommodate for unflatness in the amplitude response A(f) of the signal path 12 versus frequency f is alternatively used to implement the gain element 14.

In a typically spectrum analyzer 10, an envelop detector D_{ENV} is coupled to the gain element 14 through a resolution bandwidth filter RBW. One or more display detectors 18 are coupled to the output of the envelope detector D_{ENV} through a video filter VBW. A processing unit 16, including a memory 15 and processor 17, receives a detected signal 13 from the display detectors 18 and performs processing of the detected signal 13 to display the spectrum of the input signal 11 on a display or other output device 19. The display detectors 18 typically include one or more of an average power detector D_{PwrAVE}, a peak detector D_{PEAK} and a logarithmic averaging detector D_{logAVE}, although other types of display detectors 18 are alternatively or additionally included in the spectrum analyzer 10.

Noise sources n1, n2 are also included in the simplified block diagram of the spectrum analyzer 10. The noise source n1 represents the noise of the spectrum analyzer 10 that is in the signal path 12 prior to the gain element 14, whereas the noise source n2 represents the noise of the spectrum analyzer 10 that is contributed after the gain element 14. Since noise is contributed before the gain element 14 by the noise source n1, and after the gain element 14 by the noise source n2, noise referred to the input of the signal path 12 for example, is dependent on the gain setting of the gain element 14. A linear expression N=G(f)*n1+n2 can be used to describe the relative noise contributions of the noise sources n1, n2 to the total noise N referred to the input of the signal path 12 when the gain of the gain element 14 is set to the gain G. The gain G of the gain element 14 is generally a function of frequency f. A noise compensation method 20 according to embodiments of the present invention enables measurements of input signals 11 acquired by the spectrum analyzer 10 to be compensated for the noise N of the spectrum analyzer 10 that is contributed to the measurements.

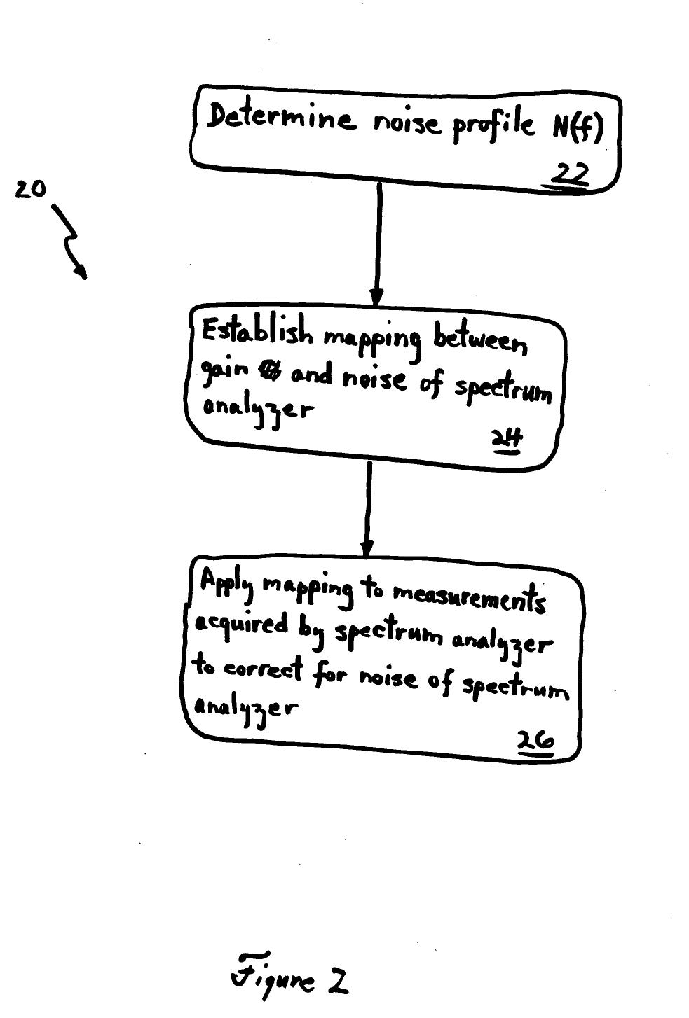

FIG. 2 shows a flow diagram of the noise compensation method 20. Step 22 of the noise compensation method 20 includes determining the noise profile N(f) associated with the spectrum analyzer 10, versus frequency f, with gain correction applied to the spectrum analyzer 10. The noise profile N(f) associated with the spectrum analyzer 10 represents the noise power, for example that would be indicated on the display of the spectrum analyzer 10, in the absence of an input signal 11 applied to the spectrum analyzer 10. In an exemplary representation of the noise profile N(f) on a logarithmic scale, the noise profile N(f) is indicated in dBm/Hz.

The gain correction includes settings of the gain G(f) of the gain element 14 at the various frequencies f within the operating frequency range of the spectrum analyzer 10 to accommodate for unflatness and other variations in the amplitude response A(f) of the spectrum analyzer 10. In one embodiment, the gain correction is established by applying an amplitude-leveled signal to the input of the spectrum analyzer 10 and then varying the gain G of the gain element 14 until the amplitude of the resulting signal at the output of the gain element 14 reaches a predetermined amplitude level that causes the amplitude response A(f) to be flat over the operating frequency range. The gain G of the gain element 14 applied at each frequency f to achieve this condition is recorded, for example, in the memory 15 of the processing unit 16 to form the gain correction G(f). The recorded gain can be the actual gain G(f) of the gain element 14, or it could be an indirect indicator of the gain G, such as the level of a drive signal d(f) that sets the gain G of the gain element 14 at each frequency f.

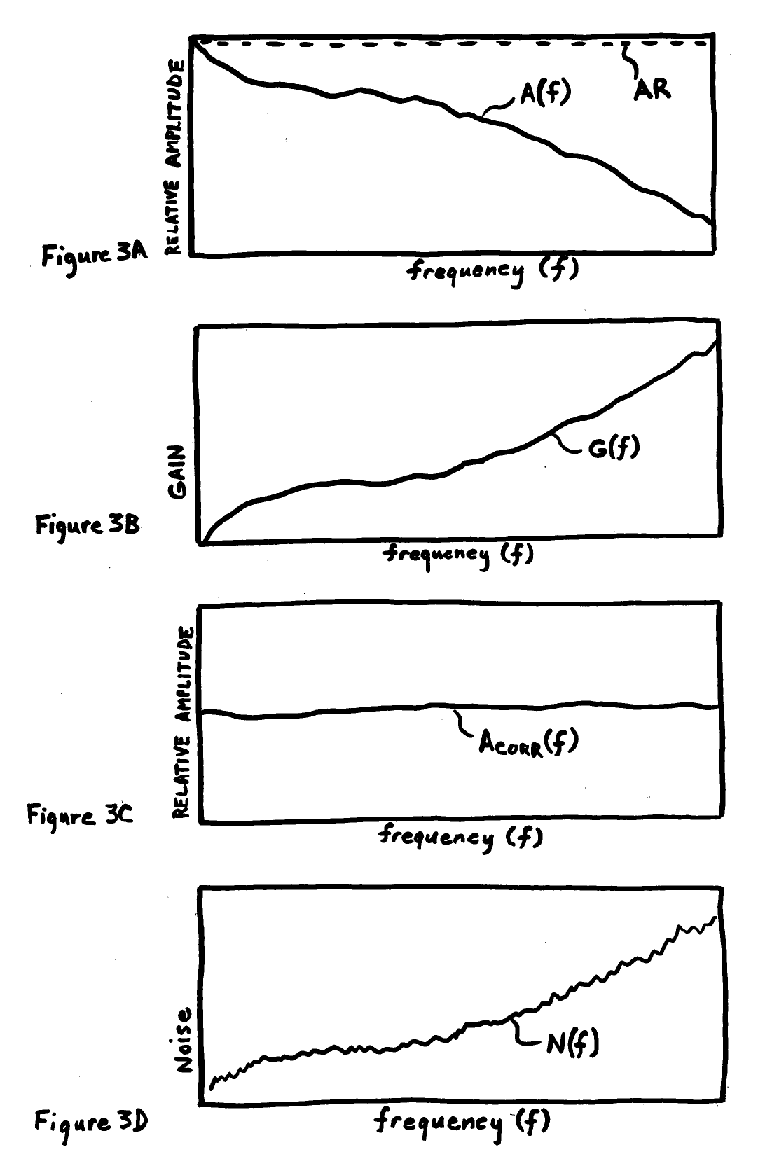

In an alternative embodiment of the present invention, the gain correction G(f) is established based on the amplitude response A(f) of the signal path 12, for example, by subtracting the amplitude response A(f) from an amplitude reference AR (indicated in FIG. 3A) at various frequencies f within the operating frequency range of the spectrum analyzer 10 and recording the difference between the amplitude reference AR and the amplitude response A(f).

FIG. 3A shows an exemplary amplitude response A(f) of the signal path 12 versus frequency f. The amplitude response A(f) generally varies versus frequency f due to frequency-dependent losses in transmission lines, filters and other components of the signal path 12, frequency-dependent conversion losses of mixers in the signal path 12, or discontinuities in the signal path 12 that are frequency dependent. In one example, the amplitude response A(f) is established by measuring the transmission response of the signal path 12 with a network analyzer, power meter, detector or other suitable system. These measurements can be acquired at a sufficient number of frequencies or frequency spacing to enable the amplitude response A(f) of the signal path 12 to be characterized to within a designated accuracy. For example, a higher number of closely-spaced measurements generally enables the established amplitude response A(f) to conform more closely to the actual amplitude response A(f) of the signal path 12 than does a lower number of widely-spaced measurements.

The measurements can also have non-uniform spacing. For example, fewer measurements made at lower frequencies can accurately characterize the amplitude response A(f) at lower frequencies because the amplitude response A(f) typically does not fluctuate as rapidly, versus frequency f, at lower frequencies than at higher frequencies. From the measurements, the amplitude response A(f) of the signal path 12 can be established using look-up tables, interpolation, curve-fitting or other suitable techniques.

The amplitude response A(f) of the signal path 12 is alternatively derived from simulations or approximations of the amplitude response A(f) of the signal path 12 versus frequency f, or from a combination of measurements of the signal path 12 and models of the signal path 12 that are based on the measurements. Linear expressions, polynomials, or other functions can also be used to estimate the amplitude response A(f) versus frequency f. FIG. 3B shows an exemplary gain correction G(f) for the signal path 12 that can be applied to the spectrum analyzer 10 to accommodate the amplitude response A(f) shown in FIG. 3A.

With the gain correction G(f) applied at the various frequencies f within the operating range of the spectrum analyzer 10, a corrected amplitude response A_{CORR}(f) for the spectrum analyzer 10 results, as shown in FIG. 3C. Since the gains G of the gain element 14 provided by the gain correction G(f) generally vary with frequency f due to the frequency dependence of the amplitude response A(f), the relative noise contributions of the noise sources n1 and n2 also vary according to frequency f. FIG. 3D shows an exemplary noise profile N(f) of the spectrum analyzer 10 versus frequency f, with the exemplary gain correction of FIG. 3B applied to the spectrum analyzer 10. This noise profile N(f) can be determined by measuring the noise power of the spectrum analyzer 10 with a display detector, such as the average power detector D_{PwrAVE}, while the appropriate gain correction G(f) is applied to the spectrum analyzer 10 versus frequency f.

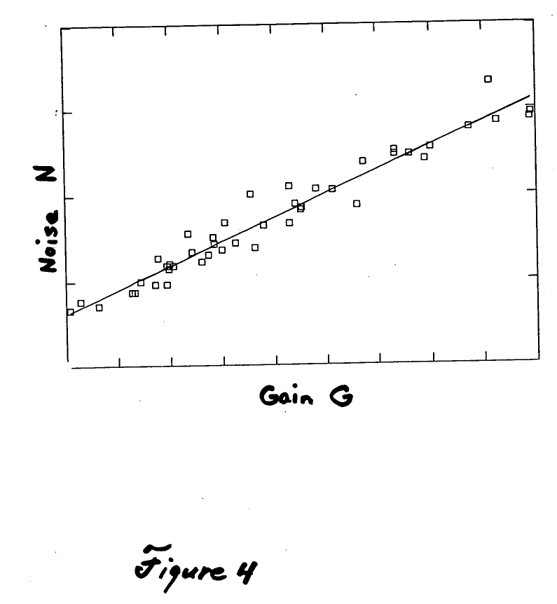

Step 24 of the noise compensation method 20 includes establishing a mapping between gain G of the gain element 14 and noise N of the spectrum analyzer 10, where the gain G is obtained base on the established gain correction G(f) versus frequency f and where the noise N is obtained based on the determined noise profile N(f) versus frequency f. FIG. 4 shows an exemplary mapping between the noise N and the gain G. In one example, the mapping is established by identifying two frequencies f1, f2 having different gains G(f1), G(f2), respectively. At the identified frequencies f1 and f2, corresponding noise N(f1), N(f2) is determined from the noise profile N(f). Thus, via the frequencies f1 and f2, a correspondence or mapping between the gains G of the gain element 14 and the noise N of the spectrum analyzer 10 is established. In this example, the mapping between gain G and the noise N is a linear. However, by determining gains G(f1), G(f2) . . . G(fn) at more than two frequencies f1, f2 . . . fn and the corresponding noise N(f1), N(f2) . . . N(fn) at these frequencies f1, f2 . . . fn, a polynomial or other curve can be fit or otherwise associated to pairs of gains and noise G(f1), N(f1); G(f2), N(f2); . . . G(fn), N(fn) to establish the mapping. From the established mapping between noise N and gain G, the noise N of the spectrum analyzer 10 can be determined based on the gain G of the gain element 14.

The mapping between the noise N and gain G can then be applied to measurements acquired by the spectrum analyzer 10 in step 26 of the noise compensation method 20. In an example where measurements M_{PwrAVE}(f) of input signals 11 are acquired by the average power detector D_{PwrAVE} of the spectrum analyzer 10, the mapping between the noise N and the gain G established in step 24 of the method 20 can be applied by subtracting, on a linear power scale, the noise N, from the measurements M_{PwrAve}(f) acquired by the spectrum analyzer 10 mapped from the corresponding gains G determined by the gain correction G(f).

In an example where measurements M_{PEAK}(f) of input signals 11 are acquired by the spectrum analyzer using the peak detector D_{PEAK} of the spectrum analyzer 10, the mapping between the noise N and the gain G established in step 24 can be applied by modifying the noise profile N(f) by a correction factor C. The correction factor C equals 10 log₁₀((logₑ(2πτBWᵢ+e)), where τ is the sweep time with which the measurements are acquired by the spectrum analyzer 10 over the operating range of frequencies f, divided by the equivalent frequency width of the frequency measurement points minus one, and where BWᵢ is the impulse bandwidth of the spectrum analyzer 10, typically 1.499 times the bandwidth of the resolution bandwidth filter RBW when the video bandwidth filter VBW is at its widest setting. Typically the correction factor C is approximately 5 dB. Then, the noise N as modified by the correction factor C, can then be subtracted, on a linear power scale, from the measurements M_{PEAK}(f) acquired by the spectrum analyzer 10 at the corresponding gains G determined by the gain correction G(f).

In an example where measurements M_{logAVE}(f) of input signals 11 are acquired by the spectrum analyzer using the logarithmic averaging detector D_{logAVE} within the spectrum analyzer 10, the mapping between the noise N and the gain G established in step 24 can be applied by modifying the noise N by a correction factor of 2.506 dB. The noise N as modified by the correction factor can then be subtracted on a linear power scale from the measurements M_{logAVE}(f) acquired by the spectrum analyzer 10 at the corresponding gains G established by the gain correction G(f).

In the embodiments of the present invention, a mapping is established between noise N of the spectrum analyzer 10 and gain G of the gain element 14 of the spectrum analyzer 10. According to alternative embodiments of the present invention, mappings can be established between noise N of the spectrum analyzer 10 and settings of a step attenuator in the signal path 12 of the spectrum analyzer 10, since the noise N increases accordingly with increases in the attenuation of the step attenuator. Mappings can also be established between noise N of the spectrum analyzer 10 and the setting of the resolution bandwidth filter RBW in the spectrum analyzer 10, the reference level setting of the spectrum analyzer 10, and any other operating condition or setting of the spectrum analyzer 10 where measurements, models or other determined relationships between the operating condition and the noise of the spectrum analyzer 10 are established.

While the embodiments of the present invention have been illustrated in detail, it should be apparent that modifications and adaptations to these embodiments may occur to one skilled in the art without departing from the scope of the present invention as set forth in the following claims.

1. A noise compensation method for a spectrum analyzer, comprising:
determining a noise profile associated with the spectrum analyzer, at a designated operating condition of the spectrum analyzer;
establishing a mapping between noise of the spectrum analyzer, based on the determined noise profile, and the designated operating condition of the spectrum analyzer; and
applying the established mapping between the noise of the spectrum analyzer and the designated operating condition of the spectrum analyzer to measurements acquired by the spectrum analyzer, to correct for the noise contributed by the spectrum analyzer to the measurements acquired by the spectrum analyzer.

2. The noise compensation method of claim 1 wherein the designated operating condition of the spectrum analyzer includes a gain of a gain correction, applied to the spectrum analyzer, versus frequency, that compensates for variations in an amplitude response of the spectrum analyzer versus frequency.

3. The noise compensation method of claim 1 wherein the noise profile represents the noise power of the spectrum analyzer versus frequency.

4. The noise compensation method of claim 2 wherein the noise profile represents the noise power of the spectrum analyzer versus frequency.

5. The noise compensation method of claim 1 wherein the designated operating condition of the spectrum analyzer includes at least one of a reference level setting, a setting of the resolution bandwidth filter, and a step attenuator setting of the spectrum analyzer.

6. The noise compensation method of claim 1 wherein applying the established mapping between the noise of the spectrum analyzer and the designated operating condition of the spectrum analyzer to measurements acquired by the spectrum analyzer to correct for the noise contributed by the spectrum analyzer includes subtracting the noise of the spectrum analyzer from the measurements acquired by the spectrum analyzer.

7. The noise compensation method of claim 1 further including modifying the noise profile by a correction factor.

8. The noise compensation method of claim 6 further including modifying the noise profile by a correction factor.

9. A noise compensation method for a spectrum analyzer, comprising:
determining a noise profile, associated with the spectrum analyzer, versus frequency with a gain correction applied to the spectrum analyzer, wherein the gain correction compensates for variations in an amplitude response of the spectrum analyzer versus frequency; and
establishing a mapping between noise of the spectrum analyzer and gain of a gain element of the spectrum analyzer, based on the gain correction and the determined noise profile.

10. The noise compensation method of claim 9 wherein determining the noise profile, associated with the spectrum analyzer, versus frequency with gain correction applied to the spectrum analyzer includes measuring noise power with a detector within the spectrum analyzer.

11. The noise compensation method of claim 9 wherein the noise profile, associated with the spectrum analyzer, versus frequency with gain correction applied to the spectrum analyzer represents noise power of the spectrum analyzer in the absence of an input signal applied to the spectrum analyzer.

12. The noise compensation method of claim 10 wherein the noise profile, associated with the spectrum analyzer, versus frequency with gain correction applied to the spectrum analyzer represents noise power of the spectrum analyzer in the absence of an input signal applied to the spectrum analyzer.

13. The noise compensation method of claim 9 wherein the gain correction is the difference between the amplitude response of the spectrum analyzer and an amplitude reference.

14. The noise compensation method of claim 10 wherein the gain correction is the difference between the amplitude response of the spectrum analyzer and an amplitude reference.

15. The noise compensation method of claim 11 wherein the gain correction is the difference between the amplitude response of the spectrum analyzer and an amplitude reference.

16. The noise compensation method of claim 9 further comprising applying the mapping between noise and gain to correct for noise of the spectrum analyzer.

17. The noise compensation method of claim 10 further comprising applying the mapping between noise and gain to correct for noise of the spectrum analyzer.

18. The noise compensation method of claim 16 wherein applying the mapping between noise and gain includes subtracting the noise from the measurements acquired by the spectrum analyzer at corresponding gain settings.

19. The noise compensation method of claim 16 wherein applying the mapping between noise and gain further includes modifying the noise of the spectrum analyzer by a correction factor.

20. The noise compensation method of claim 18 wherein applying the mapping between noise and gain further includes modifying the noise of the spectrum analyzer by a correction factor.
